(19) United States
(12) Patent Application Publication
(10) Pub. No.: US 2012/0257144 A1
(43) Pub. Date: Oct. 11, 2012

(54) LIGHT GUIDING UNIT, LIGHTING DEVICE, AND DISPLAY DEVICE

(75) Inventors: Satoshi Shibata, Osaka-shi (JP); Tsuyoshi Kamada, Osaka-shi (JP); Hideki Uchida, Osaka-shi (JP)

(73) Assignee: SHARP KABUSHIKI KAISHA, Osaka-shi, Osaka (JP)

(21) Appl. No.: 13/515,363

(22) PCT Filed: Sep. 9, 2010
(86) PCT No.: PCT/JP2010/065540

§ 371 Date: Jun. 12, 2012

(30) Foreign Application Priority Data
Dec. 28, 2009 (JP) 2009-298758

(51) Int. Cl. G02F 1/1335; G02F 1/13357

(52) U.S. Cl. 349/65; 349/193

(57) ABSTRACT

In order to provide a new light guiding unit capable of accommodating to area-active driving, and a lighting device, a lighting device (10) includes (i) a light guiding unit that includes (a) a light guiding plate (1) made of light-transmitting base material, (b) a plurality of columnar areas (4) filled with liquid crystal material, which columnar areas are provided in a direction intersecting with an in-plane direction of the light guiding plate (1), and (c) a transparent electrode with which a voltage is applied for driving the liquid crystal material, and (ii) an LED (2), as a primary light source.

### TECHNICAL FIELD

The present invention relates to a new light guiding unit, a lighting device, and a display device, each of which includes a light guiding plate.

### BACKGROUND ART

In recent years, backlights using a light guiding plate are frequently employed as a backlight (hereinafter, referred to also as B/L) used in liquid crystal display devices and like devices. The light guiding plate guides light entered from a light source, within the plane of the light guiding plate, to distribute the light in the in-plane direction. Moreover, a structure having light reflectivity is usually provided on a lower surface or an upper surface of the light guiding plate to allow for reflection of light on the structure, thereby causing the light to exit from a surface of the light guiding plate. This makes the light guiding plate function as a uniform surface light source.

The B/L including the light guiding plate can be classified based on the difference in how the light enters into the light guiding plate. For example, a B/L in which light is entered into the light guiding plate from a plurality of point light sources (e.g. light emitting diode: LED) disposed on an edge surface (edge) of the light guiding plate is called a sidelight type B/L (see Patent Literatures 1 and 2). On the other hand, a B/L in which light is entered into the light guiding plate from a plurality of point light sources provided on a lower surface (surface facing away of the surface from which light is exited) of the light guiding plate is called a direct type B/L (see Patent Literature 3).

The B/L disclosed in Patent Literature 1 includes a light guiding plate, an LED provided on an edge surface of the light guiding plate, a reflector provided on a lower surface of the light guiding plate, and a through-hole opened in the vicinity of the LED in such a manner that the through-hole penetrates through the light guiding plate. Moreover, the lower surface of the light guiding plate functions as a light diffusing plane on which a plurality of minute grains etc. (light extracting structures) are formed. Furthermore, the light guiding plate has, on an edge surface in the vicinity of the LED, a reflection section shaped of a side surface of a semicircular column, for preventing light from leaking from the edge surface. The light entered into the light guiding plate from the LED provided on the edge part of the light guiding plate is efficiently distributed in an in-plane direction of the light guiding plate through the through-hole, and the light reflected on the lower surface of the light guiding plate is exited from the upper surface (light exiting side surface) of the light guiding plate, as diffused light (see especially, FIG. 1 of Patent Literature 1).

The B/L disclosed in Patent Literature 2 includes a light guiding plate, an LED provided on an edge surface of the light guiding plate, a reflector provided on a lower surface of the light guiding plate, and a light leakage modulator provided on an upper surface (light exiting side surface) of the light guiding plate (see especially, FIG. 7 of Patent Literature 2). The light leakage modulator has a circle cylindrical low refractive index area inside a high refractive index area, and allows for propagation of a large amount of light while controlling light leakage effect up to a location far away from the LED. Namely, the B/L disclosed in Patent Literature 2 has a circle cylinder low refractive index area be provided on a layer different from the light guiding plate, and is configured to distribute (even out), in the in-plane direction, light exited to the light leakage modulator from the light guiding plate.

The B/L disclosed in Patent Literature 3 includes (i) a light guiding plate in which an aperture or projection is provided and (ii) a sidelight-type LED that is fit inside a groove provided on a plane of the light guiding plate. The aperture or projection is provided in such a manner that its side surface is substantially perpendicular to a lower surface (bottom surface; surface not from which light exits) of the light guiding plate; light emitted from the LED is entered into the light guiding plate via the aperture or projection while maintaining an angle distribution of the light, and after this light is guided through the light guiding plate, the light exits outside the light guiding plate (see FIGS. 14 and 23 of Patent Literature 3). Note that the aperture may be penetrated through or not penetrated through the light guiding plate.

### CITATION LIST

### Patent Literature

Patent Literature 1

Japanese Patent Application Publication, Tokukai, No. 2001-035229 A (Publication Date: Feb. 9, 2001)

Patent Literature 2

Japanese Patent Application Publication, Tokukai, No. 2002-222604 A (Publication Date: Aug. 9, 2002)

Patent Literature 3

International Publication No. WO 2006/107105 A2 (International Publication Date: Oct. 12, 2006)

### SUMMARY OF INVENTION

### Technical Problem

However, the conventional B/L disclosed in Patent Literatures 1 and 2 have a common problem that the B/L cannot accommodate to a liquid crystal display device and the like that employs area-active driving. The area-active driving (local dimming) is a driving method that divides a display section of the liquid crystal display device or the like into a plurality of areas when driving the device, in order to improve contrast of a display and the like.

Namely, in order to accommodate the B/L to the area-active driving, light is necessarily exited from the light guiding plate upon invalidating light guiding conditions of the light guiding plate in a desired area thereof. Namely, in an area of the light guiding plate from which no light is to be exited, the light guiding condition is necessarily stored so that light is distributed to just within the plane of the light guiding plate (i.e. so that no light exits outside the plane). However, in the B/L disclosed in Patent Literatures 1 and 2, the optical path changes not only in a direction within the plane of the light guiding plate but also in a direction exiting outside the plane. This as a result becomes a cause of light leakage.

Furthermore, the B/L disclosed in Patent Literature 1 is basically an invention related to a B/L for use in mobile LCDs (Liquid Crystal Displays), which use one LED. Since this B/L is only given consideration to a configuration in the vicinity of a light entering part of the LED, there also is the problem that it is difficult to accommodate this technique to a liquid crystal display device or the like having a large area.

Meanwhile, the B/L disclosed in Patent Literature 3 is of a completely different method as the B/L disclosed in Patent Literatures 1 and 2. Accordingly, it is possible to accommodate the B/L disclosed in Patent Literature 3 to the area-active driving to a certain degree, by storing the sidelight type LED inside a plurality of grooves that are provided at appropriate intervals within a plane of the light guiding plate, and by independently controlling the on and off of the LED.

However, the B/L disclosed in Patent Literature 3 is of the direct type, and thus has a problem that the required number of LEDs becomes relatively greater as compared to that of the sidelight type B/L. Moreover, as also disclosed in Patent Literature 3, use of the sidelight type LED also has a problem that it is necessary to take measures for the light that exits in an upper direction of the LED; a point generated as a result of taking this measure becomes a defect from which light cannot be emitted.

Furthermore, a problem common for all Patent Literatures 1 to 3 is that the conventional B/L has light distributed evenly within the light guiding plate, and that the light cannot be distributed selectively to a predetermined area within the light guiding plate. Accordingly, when this technique is applied to the area-active driving, light is distributed also to an area in which no display is carried out. This causes another problem that the amount of light distributed to the areas in which display is carried out decreases (light loss).

The invention of the present application is accomplished in view of the foregoing problems, and a main object thereof is to provide a new light guiding unit, lighting device, and display device, each of which can be accommodated to area-active driving.

### Solution to Problem

In order to attain the object, a light guiding unit according to the present invention includes: a light guiding plate made of light-transmitting base material; a plurality of columnar areas provided in a direction intersecting with an in-plane direction of the light guiding plate, each of which is filled with liquid crystal material; and a transparent electrode with which a voltage is applied for driving the liquid crystal material.

According to the configuration, a refractive index of light in a columnar area changes depending on whether or not a voltage is applied to the liquid crystal material filled in the columnar area. Namely, the refractive index of the columnar area can be switched between a case in which the refractive index is made closer to that of the base material of the light guiding plate and a case in which the refractive index is made more different from that of the base material of the light guiding plate.

As a result, the light entering the columnar area upon propagating through the light guiding plate in the in-plane direction either (i) refracts and disperses in the in-plane direction of the light guiding plate or (ii) progresses straight forward substantially without refracting, depending on whether or not a voltage is applied to the liquid crystal material. Namely, freely controlling the forward progression or refraction of the light that progresses within the light guiding plate allows for providing a light guiding unit that can distribute light of a desired amount to a desired area within the light guiding plate.

Moreover, the present invention provides a lighting device including the light guiding unit and at least one primary light source disposed on an edge surface of the light guiding plate. The present invention further provides a display device including the lighting device as a backlight.

### Advantageous Effects of Invention

The present invention brings about an effect of allowing for providing a new light guiding unit or the like that is capable of distributing light of a desired amount to a desired area within a light guiding plate, and that can accommodate to area-active driving.

### BRIEF DESCRIPTION OF DRAWINGS

FIG. 1 is a perspective view schematically illustrating a configuration of a lighting device according to the present invention.

FIG. 2 Illustrated in (a) of FIG. 2 is a schematic top view of the configuration of the lighting device of FIG. 1, and (b) of FIG. 2 is a schematic side view illustrating the configuration of the lighting device of FIG. 1.

FIG. 3 Illustrated in (a) and (b) of FIG. 3 are schematic views of an electrode configuration for applying a voltage to a light guiding plate unit provided in the lighting device of FIG. 1, and (c) of FIG. 3 is a view illustrating a state in which a voltage is applied to a partial area of the light guiding plate.

FIG. 4 is a cross sectional view schematically illustrating an example of a light extraction layer.

FIG. 5 Illustrated in (a) of FIG. 5 is a schematic cross sectional view of another example of a light extraction layer, and (b) of FIG. 5 is a view schematically illustrating a comb-shaped electrode that is provided in the light extraction layer.

FIG. 6 is a view schematically illustrating another electrode configuration for applying a voltage on a light guiding plate unit provided in the lighting device illustrated in FIG. 1.

FIG. 7 is a view schematically illustrating another configuration of a light guiding plate unit provided in the lighting device illustrated in FIG. 1.

FIG. 8 is a top view schematically illustrating yet another electrode configuration for applying a voltage on a light guiding plate unit provided in the lighting device illustrated in FIG. 1.

### DESCRIPTION OF EMBODIMENTS

### Embodiment 1

(Basic Configuration of Light Guiding Unit and Lighting Device)

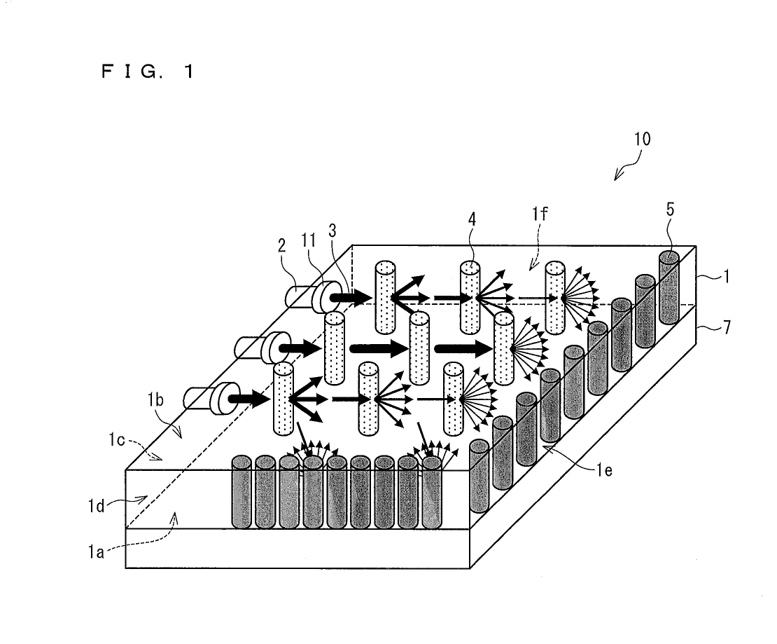

Described below is an example of basic configurations of a light guiding unit including a light guiding plate of the present invention, and a lighting device, with reference to FIGS. 1 to 3.

A lighting device 10 of the present invention includes: a light guiding plate 1; a plurality of LEDs (light emitting diodes: Light Emitting Diodes) 2 serving as primary light sources (point light sources); and a light extraction layer 7. The light extraction layer 7 makes light entered from the light guiding plate 1 exit outside the light guiding plate 1, so that the lighting device 10 serves as a secondary light source. Namely, the lighting device 10 provides a mechanism (light guiding plate 1) for broadly guiding light entered from the primary light sources, separately from a mechanism (light extraction layer 7) for extracting the guided light. Hence, as compared to a case in which both mechanisms are accomplished in one configuration within the light guiding plate, controlling of the extraction of the guided light is made easier.

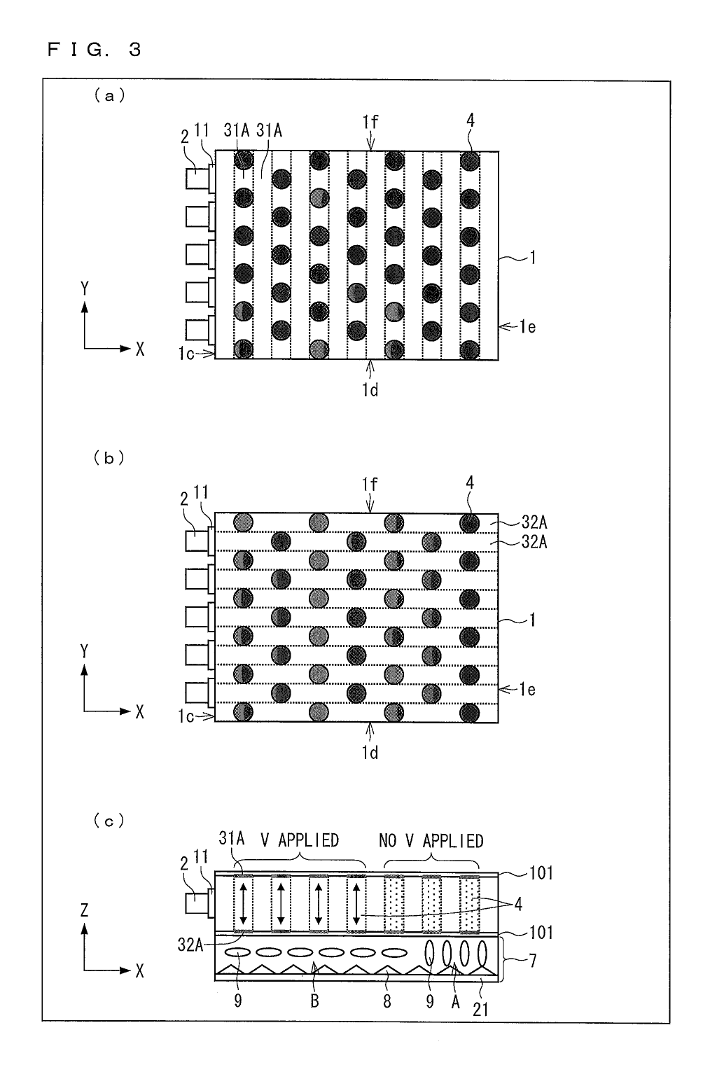

Moreover, the light guiding plate 1 includes a plurality of columnar areas (columnar areas) 4 that are filled with liquid crystal material. Furthermore, the lighting device 10 includes electrodes 31A and 32A that apply a voltage for driving the liquid crystal material filled in the columnar areas 4 (see FIG. 3). The liquid crystal material filled in the columnar areas 4 is driven by having the liquid crystal material be applied a voltage; this causes a change to its oriented state. As a result, light 3 that is emitted from the LEDs 2 and entered into the columnar areas 4 is either refracted and dispersed in the in-plane direction of the light guiding plate 1 or progresses straight forward by substantially not being refracted. As such, in the lighting device 10, a desired amount of light is distributed to a desired area within the light guiding plate 1, by freely controlling the forward progression or the refraction (dispersion in the in-plane direction of the light guiding plate 1) of the light 3 that progresses within the light guiding plate 1.

Furthermore, for example, by controlling so that light is emitted just from a desired area of the surface of the light guiding plate 1 as described later, it is possible to provide a backlight unit that accommodates to the area-active driving of the display device. The following description deals with a specific configuration of the lighting device 10. In the present embodiment, the lighting device 10 in which no LED 2 (i.e. primary light source) is mounted is defined as a “light guiding unit”, which does not emit light by itself but guides light that is entered into the lighting device 10. Moreover, the “light guiding unit” also includes in its scope a lighting device 10 that mounts neither of the LED 2 nor the light extraction layer 7.

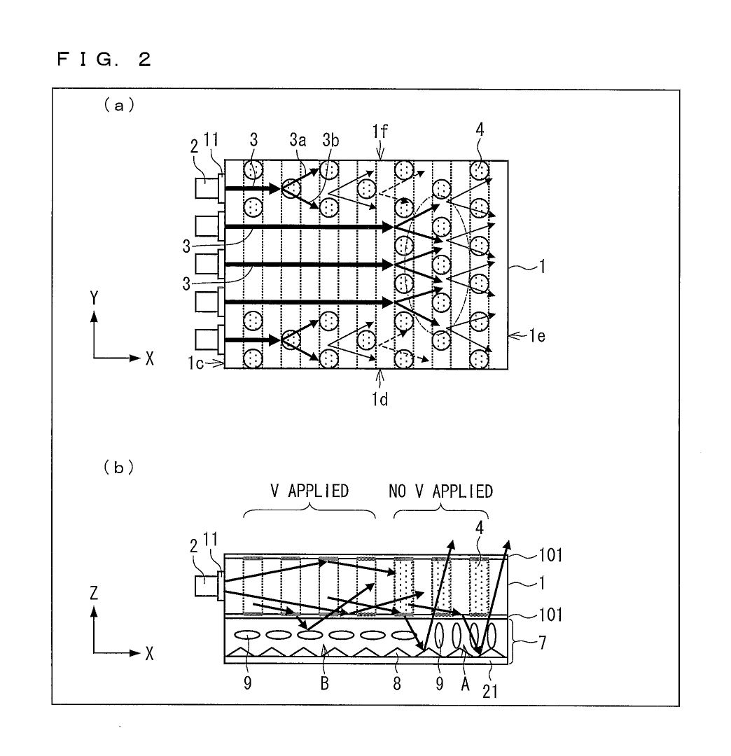

The light guiding plate 1 is a flat plate member shaped as for example a rectangle, made of light-transmitting base material (light guiding plate medium) commonly known as material for a light guiding plate, such as glass, acrylic resin, epoxy resin, and the like. The light guiding plate 1 has four edge surfaces 1c to 1f, an upper surface (displaying side surface) 1b, and a lower surface 1a. Of the four edge surfaces 1c to 1f, one edge surface 1c has light source mounting sections 11 (see FIG. 2) for mounting the primary light sources, and the plurality of LEDs 2 are mounted to the light source mounting sections 11. The three edge surfaces 1d, 1e, and 1f on which no LED 2 is mounted have circle cylinder light reflecting materials 5 closely packed thereon, in such a manner that side surfaces of the light reflecting materials are in contact with each other. Namely, on the edge surfaces 1d, 1e, and 1f, the light reflecting materials 5 are arranged so that one piece of light reflecting wall is formed, which light reflecting wall regularly projects in a curved plate shape inside the light guiding plate 1. The light reflecting member is made of material on which a film made of reflective material is formed, for example aluminum, silver, or dielectric multilayer reflection film.

More specifically, for example, the light reflecting materials 5 are disposed by providing wire-shaped metal thin lines on the edge surfaces 1d, 1e, and 1f of the light guiding plate 1. The metal thin lines may be of any diameter, however in view of easy production, it is preferable that the metal thin lines are of wire having a diameter of approximately 50 um to 100 um. Moreover, fine metal thin lines such as nanowire may also be used as the light reflecting materials 5. The metal thin lines may be disposed by methods such as adhesion with resin, heat sealing, or like method. Moreover, it is also possible to use a method in which a film on which metal thin lines are closely packed is prepared in advance, and this film is adhered to the edge surface of the light guiding plate by use of air sandwiched therebetween.

Instead of providing the light reflecting material 5, it is also possible to process the edge surfaces 1d, 1e, and 1f of the light guiding plate 1 so that the edge surfaces 1d, 1e, and 1f possess functions equivalent to the light reflecting materials 5. More specifically, for example cylindrical through-holes are formed on the edge surfaces 1d, 1e, and 1f of the light guiding plate 1. Next, the edge surfaces 1d, 1e, and 1f are cut so that cross sections of the through-holes are made into approximate semicircles, and thereafter reflective material is formed on its surface, such as an aluminum, silver, or dielectric multilayer reflection film.

A plurality of columnar areas 4 (columnar areas) are formed inside the light guiding plate 1, which columnar areas 4 extend in a direction intersecting with an in-plane direction (direction in which a plate surface of the light guiding plate 1 spreads) of the light guiding plate 1. More specifically, in the present embodiment, the columnar areas 4 are hollow sections that extend in a substantially perpendicular direction to the in-plane direction of the light guiding plate 1 and whose upper ends and lower ends are sealed; the columnar areas 4 are completely filled with liquid crystal material. That is to say, in the present embodiment, a length of the columnar areas 4 is substantially the same as a thickness of the light guiding plate 1. A sealing method of the liquid crystal material within the columnar areas 4 is not particularly limited, however for example, the following configuration may be employed: thin films 101 made of light-transmitting base material such as glass, acrylic resin and epoxy resin, which material are commonly known as material of a light guiding plate, are provided on an upper surface and lower surface of the light guiding plate 1, to prevent leakage of the liquid crystal material (see (b) of FIG. 2). It is preferable that the thin films 101 are made of the same base material as the light guiding plate 1 and are provided as a part of the light guiding plate 1.

In the present specification, the in-plane direction of the light guiding plate 1 denotes, in principle, a horizontal direction with respect to the upper surface 1b and the lower surface 1a. However, when the upper surface 1b and the lower surface 1a are not parallel to each other, the in-plane direction denotes a horizontal direction within a plane of equal distance from the upper surface 1b and the lower surface 1a (i.e. mid plane of the light guiding plate 1).

(Control of Refractive Index in Columnar Area)

The liquid crystal material filled in the columnar areas 4 changes in its oriented state by having the liquid crystal material be applied a voltage. Consequently, the refractive index of light changes between the columnar areas 4 in a state in which a voltage is applied to the liquid crystal material (when a voltage is applied) and those in a state in which no voltage is applied (when no voltage is applied). A specific example is that a refractive index of light of the columnar areas 4 is substantially equal to that of the light-transmitting base material (light guiding plate medium) that makes up the light guiding plate 1 in a state in which a voltage is applied to the liquid crystal material, whereas the refractive index of light of the columnar areas 4 is different from the refractive index of the base material in a state in which no voltage is applied. Alternatively, the refractive index of light with the columnar areas 4 may be substantially equal to that of the light-transmitting base material making up the light guiding plate 1 in the state in which no voltage is applied to the liquid crystal material, and be different from the refractive index of the base material in a state in which a voltage is applied to the liquid crystal material. When the refractive index is substantially equal between the columnar areas 4 and the base material, the light 3 emitted from the LED 2 and entered into the columnar areas 4 on an incident angle substantially parallel to the in-plane direction of the light guiding plate 1 passes through the columnar areas 4 without being refracted or the like, and again enters into the base material part of the light guiding plate 1. On the other hand, when the refractive index substantially differs between the columnar areas 4 and the base material, the light 3 emitted from the LEDs 2 and entered into the columnar areas 4 on an incident angle substantially parallel to the in-plane direction of the light guiding plate 1 refracts when the light 3 enters and exits the columnar areas 4; the light 3 is evenly scattered (distributed) and again entered into the base material part of the light guiding plate 1. Namely, in the lighting device 10, the refractive indices of the columnar areas 4 are modifiable independently; this allows for, for example, switching the refractive indices of the columnar areas 4 between a state in which the refractive index of the columnar areas 4 is equal to that of the base material of the light guiding plate (columnar areas 4 being in a transparent state) and a state in which the refractive indices are different from each other (columnar areas 4 being in a distributed state).

Although not particularly limited, in view that the refractive index is more easily controllable, the liquid crystal material (birefringent material) to be filled in the columnar areas 4 is preferably uniaxial liquid crystal material. As long as either one of an ordinary index or an extraordinary index of the liquid crystal material is substantially the same as the refractive index of the light-transmitting base material making up the light guiding plate 1, it is possible to make the refractive index of light of the columnar areas 4 be substantially the same as the refractive index of light of the base material of the light guiding plate 1, by arranging a long axis or a short axis of the liquid crystal material in a direction (i) perpendicular to the extending direction of the columnar areas 4 (same meaning as the direction parallel to the upper surface 1b of the light guiding plate 1) and (ii) along a direction in which light emitted from the LED 2 is propagated (entered), depending on whether or not a voltage is applied to the liquid crystal material. Note that in the transparent state, it is more preferable to have the liquid crystal material be oriented so that the ordinary index is exhibited in a direction in which the light emitted from the LED 2 is propagated. Namely, it is more preferable to have the liquid crystal material be oriented substantially parallel to the display surface (i.e. upper surface 1b of the light guiding plate 1) and have a long axis of the liquid crystal material be oriented so as to extend towards the LED 2 (LED light entering section).

Specifically described below is an example of a case in which the ordinary index of the liquid crystal material is substantially the same as the refractive index of the light-transmitting base material that makes up the light guiding plate 1. In this case, when the columnar areas 4 are in the transparent state, the long axis of the liquid crystal material is oriented so as to extend towards the LED 2 (LED light entering section). Hence, although light that propagates the light guiding plate 1 experiences the ordinary index of the liquid crystal material, no refraction or reflection occurs since the refractive index of the liquid crystal material is equal to that of the light guiding plate 1. On the other hand, in the distribution state, the liquid crystal material is oriented in a substantially perpendicular direction to the display surface for example, by being effected by the electric field. As a result, the light propagating the light guiding plate 1 exhibits an extraordinary index of the liquid crystal material. Since the extraordinary index differs from the refractive index of the light guiding plate 1, the light 3 refracts or is reflected in the columnar areas 4. Depending on the shape of the columnar areas 4, the light 3 entered into the columnar areas 4 from the light guiding plate 1 is distributed within the light guiding plate 1. The columnar areas (refractive index changeable section) 4 preferably are configured standing perpendicularly to the display surface (i.e. the upper surface 1b of the light guiding plate 1). For example, when the extraordinary index of the liquid crystal material is greater than the refractive index of the light guiding plate 1, the light 3 entered into the columnar areas 4 bends in an angle shallower than its incident angle as to the direction perpendicular to the display surface. Hence, it is possible to distribute light more positively in just the in-plane direction, without the light exiting from the display surface.

There is no particular limitation in the combination of the base material of the light guiding plate 1 and the liquid crystal material that may possibly have a substantially equal refractive index, however specific examples include, for example, acrylic resin with nematic liquid crystal, glass with nematic liquid crystal, and epoxy resin with nematic liquid crystal.

Moreover, although the liquid crystal material may be oriented in a predetermined direction while no voltage is applied (i.e. may be oriented with a predetermined pretilt angle with respect to the surface of the light guiding plate 1), the liquid crystal material is not necessarily oriented in a predetermined direction. Namely, the liquid crystal material may be an isotropic material as like a liquid crystal material that exhibits cholesteric blue phase, while no voltage is applied. By using optically isotropic material while no voltage is applied, it is possible to have a refractive index difference between the columnar areas 4 and the base material of the light guiding plate 1 (light guiding plate medium) be zero with respect to all incident angles of all polarization components. This allows for extracting a large difference between the voltage applied state and voltage non-applied state.

The columnar areas 4 are arranged regularly to the arrangement of the plurality of LEDs 2. Clearly, the plurality of columnar areas 4 are arranged along a direction in which the plurality of LEDs 2 are arranged on the edge plane 1c. Provided that the rows of the columnar areas 4 are named first row, second row, third row and so on from rows closer to the LEDs 2, the plurality of columnar areas 4 aligned in the first row and the plurality of columnar areas 4 aligned in the second row are arranged alternately to each other (what is called a zigzag arrangement). Namely, when viewed from the edge plane 1c, the columnar areas 4 provided in the second row are aligned so as to fill respective spaces between adjacent columnar areas 4 provided in the first row. The other adjacent rows such as the second and third rows also have the columnar areas 4 be arranged as such.

As shown in FIGS. 1 and 2, the LEDs 2 mounted on the edge surface 1c of the light guiding plate 1 emits light 3 that has strong directivity, into the light guiding plate 1. If the refractive index differs between the columnar areas 4 and the base material of the light guiding plate, the light 3 entered into the light guiding plate 1 refracts when the light 3 enters the columnar areas 4, and further changes its optical path in the in-plane direction of the light guiding plate 1 (the refracted light is shown as light 3a and 3b). Hence, the light 3 is evenly distributed so that it spreads in the in-plane direction of the light guiding plate 1.

Furthermore, the columnar areas 4 have a side surface substantially perpendicular to the in-plane direction (upper surface 1b, which is a light exiting surface) of the light guiding plate 1. Accordingly, although a progressing direction of the guided light 3 in the thickness direction of the light guiding plate changes by refraction at a point in time when the light 3 enters the columnar areas 4, the angle returns back to its original angle when the light 3 exits the side surface of the columnar area 4 and re-enters into the light guiding plate 1. This allows for the optical path to be maintained. Namely, the incident angle of the light 3 with respect to the light guiding plate 1 is maintained as it is for an entire time while the light 3 is guided within the light guiding plate 1. Hence, by use of the light guiding plate 1, it is possible to evenly distribute the light 3 just in the in-plane direction while maintaining the light guiding conditions.

When the refractive index of the columnar areas 4 differs with that of the base material of the light guiding plate, the light 3 is refracted and distributed every time the light 3 enters a columnar area 4. This causes a quantity of light (light intensity) per unit area to decrease. Accordingly, when light is to be distributed to just a predetermined partial area on the light guiding plate 1 in response to a request of area-active driving or the like, the refractive index of the columnar areas 4 is to be modulated, as illustrated in FIG. 2.

FIG. 2 is a view illustrating an example of modulating the refractive index of the columnar areas 4 in the light guiding plate 1, in a case in which an area to which light is distributed (selected area circled in an oval shape in FIG. 2) is on an edge surface le side that opposes the edge surface 1c on which the LEDs 2 are provided, which LEDs 2 serve as the primary light source. In FIG. 2, the thickness of the lines of the light 3 indicates its light intensity. As illustrated in FIG. 2, an area (non-selected area) that does not require light to be distributed in the light guiding plate 1 exists between the LEDs 2 and the selected area. A voltage is applied to the columnar areas 4 that are positioned in this non-selected area of the light guiding plate 1, whereas no voltage is applied to other columnar areas 4 including the selected area. As a result, the refractive index of the columnar area 4 positioned in the non-selected area becomes substantially equal to that of the base material of the light guiding plate, which allows for light entered into the columnar areas 4 to pass through the columnar areas 4 without substantially being refracted. Hence, the light emitted by the LEDs 2 reaches the selected area while maintaining the quantity of light per unit area (i.e. without being distributed or the like). In the non-selected area, light that reaches the upper surface 1b or the lower surface 1a of the light guiding plate 1 is basically totally reflected on its interface as illustrated in (b) of FIG. 2, and is guided within the light guiding plate 1. Hence, no light is undesirably leaked from the upper surface 1b of the light guiding plate 1. The effect of preventing undesired leakage of light from the light guiding plate 1 becomes remarkable by satisfying one of (1) and (2), or preferably both (1) and (2): (1) having the refractive index (ordinary index or extraordinary index) of the columnar areas 4 be greater than the refractive index of the base material of the light guiding plate (the larger the difference in refractive index between the columnar areas and the base material, the more preferable) and (2) having the light emitted from the LEDs 2 have a strong directivity and an incident angle of light on the upper surface 1b or lower surface 1a be relatively shallow.

On the other hand, the refractive index differs between the columnar areas 4 positioned in the selected area and that of the light guiding plate. Hence, the light entering the columnar areas 4 refracts and scatters, and repeats the distribution of light to its surroundings in an even manner (uniformly).

Thereafter, by having light entering the light extraction layer 7 from the selected area of the light guiding plate 1 be exited from the upper surface (display side) 1b of the light guiding plate 1, based on control described later, it is possible to use the lighting device 10 as a surface light source that emits light selectively from the selected area. While the light passes through the non-selected area of the light guiding plate 1, no light is distributed to its surroundings. Hence, it is possible to guide the light to the selected area in a concentrated manner. As a result, the lighting device 10 serves as a surface light source exhibiting a high peak luminance, which lighting device 10 corresponds to the selected area.

(Electrode Configuration that Drives Liquid Crystal Material)

Described below is an example of an electrode configuration that allows for independently controlling refractive indices of the plurality of columnar areas 4, according to FIG. 3. Schematically illustrated in (a) of FIG. 3 is a view of a configuration of the light guiding plate 1 from its upper surface 1b (see FIG. 1) perspective, and (b) is a view schematically illustrating a configuration of the light guiding plate 1 from its lower surface 1a (see FIG. 1) perspective.

As illustrated in (a) of FIG. 3, the upper surface 1b of the light guiding plate 1 has a plurality of electrodes 31A provided parallel to each other at predetermined intervals, which electrodes 31A each extend along an arranged direction of the plurality of LEDs 2 (direction in which the edge surface 1c or 1e of the light guiding plate 1 extends). Each of the electrodes 31A is provided corresponding to a respective row including the plurality of columnar areas 4 aligned in the extended direction of the electrodes 31A. Namely, among the edge sections of the columnar areas 4, the edge sections positioned on the upper surface 1b side of the light guiding plate 1 are covered by the electrodes 31A. The electrodes 31A are electrically disconnected from each other, however are each electrically connected to the upper surface electrode drive circuit (first driver: not illustrated). The upper surface electrode drive circuit supplies a driving signal (voltage signal) independently to each of the electrodes 31A. The electrodes 31A are formed, for example, on a surface of the upper thin film 101 facing the columnar areas 4 (see (b) of FIG. 2).

On the other hand, as illustrated in (b) of FIG. 3, a plurality of electrodes 32A are provided parallel to each other at predetermined intervals (not illustrated) on the lower surface (back surface) 1a of the light guiding plate 1, which electrodes 32A extend along a progressing direction of the light emitted from the LEDs 2 (direction in which the edge surfaces 1d and 1f of the light guiding plate 1 extend). Namely, the extending direction of the electrodes 32A intersects at right angles with the extending direction of the electrodes 31A. The electrodes 32A are provided corresponding to respective rows including the plurality of columnar areas 4 extending in the extending direction of the electrodes 32A. Namely, of the edge sections of the columnar areas 4, edge sections that are positioned on the lower surface 1a side of the light guiding plate 1 are covered by the electrodes 32A. The electrodes 32A are electrically disconnected to each other however are electrically connected to a lower surface electrode drive circuit (second driver: not illustrated). The lower surface electrode drive circuit supplies a drive signal (voltage signal) to the electrodes 32A independently. The electrodes 32A are formed, for example, on a surface of the lower thin film 101 facing the columnar areas 4 (see (b) of FIG. 2). Moreover, the electrodes 31A and 32A are made of transparent electrode material such as ITO or the like.

The upper surface electrode drive circuit and the lower surface electrode drive circuit may be provided in the light guiding unit or the lighting device 10, or alternatively, may be provided in a display device in which the lighting device 10 is mounted.

As described above, the columnar areas 4 are sandwiched between the electrodes 31A and electrodes 32A. Moreover, a combination of the pair of the electrodes 31A and 32A that sandwich the respective columnar areas 4 differs for each columnar area 4. Hence, application of a voltage between one pair of the electrode 31A and electrode 32A allows for driving the liquid crystal material filled in the columnar areas 4 in an independent manner, and allows for changing its refractive index.

When the light 3 distributed in the in-plane direction of the light guiding plate 1 reaches the edge surfaces 1d, 1e, and 1f, the light 3 (stray light) is reflected on the side surface of the light reflecting materials 5, and is again guided inside the light guiding plate 1. This makes it possible to prevent light from being undesirably leaked (loss of light) from the light guiding plate 1, thereby further improving use efficiency of light supplied from the primary light source (LEDs 2).

(Configuration of Light Extraction Layer)

As illustrated in FIG. 2 and FIG. 3, the light extraction layer 7 is provided on the lower surface 1a (one surface) side of the light guiding plate 1, and includes light reflecting members 8 that reflect light entered from the light guiding plate 1 so that the light exits via the upper surface 1b facing away of the lower surface 1a. The light extraction layer 7 further includes a shutter member that is provided between the light guiding plate 1 and the light reflecting member 8, which shutter member enables the switching over between transmission and non-transmission of light (light transmission state) or between transmitting and scattering of light. More specifically, the light extraction layer 7 is configured including the light reflecting members 8 having a reflective surface made of light reflective material such as aluminum, silver, dielectric mirror or the like, and a liquid crystal layer (shutter member) 9 including liquid crystal material. The light extraction layer 7 is disposed so that the light reflecting members 8 face the light guiding plate 1 in such a manner that the liquid crystal layer 9 is sandwiched between the light reflecting members 8 and the light guiding plate 1. The light extraction layer 7 has a square area substantially equal to the square area of the lower surface 1a of the light guiding plate 1, and the light extraction layer 7 is provided so as to cover the entire lower surface 1a of the light guiding plate 1.

The light reflecting members 8 are members shaped of a triangular prism, each of which extend in a direction along the direction in which the columnar areas 4 are aligned in the light guiding plate 1 (i.e. direction in which the LEDs 2 are aligned). A bottom surface of the light reflecting members 8 is of an isosceles triangular shape in which one vertex angle is an obtuse angle. The plurality of light reflecting members 8 are fixed to the substrate 21 on a side facing the obtuse vertex angle. The plurality of light reflecting members 8 fixed onto the substrate 21 is closely packed on the substrate 21. Hence, the plurality of light reflecting members 8 form a continuous light reflective surface on the substrate 21, on which crest and trough are continuously provided. Namely, the lighting device 10 has a configuration in which the liquid crystal layer 9 is sandwiched between the continuous light reflective surface made of the plurality of light reflecting members 8, and the light guiding plate 1.

The light 3 that is guided inside the light guiding plate 1 enters into the light extraction layer 7. However, as described above, when the refractive index of the base material making up the light guiding plate 1 agrees with the refractive index of the columnar areas 4 (i.e. in the non-selected area of the light guiding plate 1), propagation of the light 3 by total reflection is superior on the interface of the light extraction layer 7 with the light guiding plate 1. Moreover, as described later, the area of the light extraction layer 7 corresponding to the non-selected area of the light guiding plate 1 (area B in (b) of FIG. 2 and area B in (c) of FIG. 3) is controlled so that the liquid crystal layer 9 reflects light. Hence, the light 3 is entered from the light guiding plate 1 into the light extraction layer 7 mainly in the selected area of the light guiding plate 1.

The light entered into the light extraction layer 7 first reaches the liquid crystal layer 9. The liquid crystal layer 9 serves as a shutter that allows for switching between states of having the entered light 3 pass through and having the entered light be reflected (not passed through), based on whether or not a voltage is applied. Clearly, the shutter is made by including (i) the liquid crystal layer 9, (ii) a pair of drive electrodes facing each other so as to sandwich the liquid crystal layer 9 therebetween, and (iii) a liquid crystal drive circuit (not illustrated) that applies a voltage signal between the electrodes. The shutter drives the liquid crystal layer 9 independently (divisional drive) by dividing the liquid crystal layer 9 into a plurality of areas. Hence, as illustrated in FIG. 3, the oriented state of the liquid crystal molecules change in the liquid crystal layer 9, between the area B in which a voltage is applied and the area A in which no voltage is applied. For example, when liquid crystal molecules of a vertical alignment type is used, the liquid crystal molecules in the area B are oriented in a direction parallel to the light extraction layer 7, whereas in the area A, the liquid crystal molecules are oriented in a direction perpendicular to the light extraction layer 7 (see (c) of FIG. 3).

As a result, the light entered from the light guiding plate 1 to the area B of the liquid crystal layer 9 is guided inside the light guiding plate 1, after the light has been totally reflected by the liquid crystal molecules. The light 3 propagates the light guiding plate 1 while the angle at the time when entering the light guiding plate 1 (i.e. a substantially horizontal direction of the in-plane direction of the light guiding plate 1) is substantially maintained, and enters the light extraction layer 7. Hence, the angle of the total reflection by the liquid crystal molecules is relatively shallow; the light 3 entered again into the light guiding plate 1 from the light extraction layer 7 is guided so as to be evenly spread in the in-plane direction of the light guiding plate 1.

On the other hand, the light 3 that enters the area A of the liquid crystal layer 9 from the light guiding plate 1 reaches the continuous light reflective surface made of the light reflecting members 8, by passing through the liquid crystal molecules. Thereafter, the light 3 is reflected on the continuous surface. Since this continuous surface has a repeated configuration of the crest and trough as described above, the light 3 is totally reflected in an acute angle. This causes the light 3 totally reflected on the continuous surface to be entered into the light guiding plate 1 at an acute angle. As a result, the light 3 exits from the upper surface 1b of the light guiding plate 1 without being guided inside the light guiding plate 1 in the in-plane direction.

Namely, the lighting device 10 emits light just from an area on the light guiding plate 1 that corresponds to the area A of the liquid crystal layer 9 (corresponding to the selected area of the light guiding plate 1). On the other hand, in the area on the light guiding plate 1 that corresponds to the area B of the liquid crystal layer 9 (corresponding to the non-selected area of the light guiding plate 1), just the distribution (guiding) of light in the in-plane direction of the light guiding plate 1 is substantially carried out, and no external emission of light is carried out.

As exemplified, it is preferable that control of the liquid crystal layer 9 included in the light extraction layer 7 be carried out together with control of the refractive index of the columnar areas 4 provided in the light guiding plate 1. Namely, when light is to be exited from the entire upper surface 1b of the light guiding plate 1, the refractive indices of all the columnar areas 4 are controlled to be different from the refractive index of the base material of the light guiding plate 1, and the light extraction layer 7 is to be controlled so that the light 3 entered into the light extraction layer 7 is exited via the upper surface 1b of the light guiding plate 1. By controlling as such, the lighting device 10 functions as a surface light source that emits light uniformly from the entire surface. In this case, a display device that includes the lighting device 10 as a backlight is not driven based on area-active driving.

On the other hand, when light is to be emitted from a partial area (the selected area) of the upper surface 1b of the light guiding plate 1, control is carried out so that the refractive index of the columnar areas 4 that are positioned in the selected area is different from the refractive index of the base material of the light guiding plate 1, and that the refractive index of the columnar areas 4 in the area from which no light is exited (corresponding to the non-selected area) that are positioned between the primary light source and the selected area, is substantially the same as the refractive index of the base material of the light guiding plate 1. Furthermore, the light extraction layer 7 controls so that the light 3 entered into the light extraction layer 7 is exited just from the selected area of the upper surface 1b of the light guiding plate 1. This control allows for the lighting device 10 to substantially function as a surface light source that emits light uniformly, substantially from just the selected area. In this case, the display device including the lighting device 10 as a backlight is being driven based on area-active driving.

As described above, in the lighting device 10, it is possible to distribute light in a focused manner to a desired area (selected area) within the light guiding plate 1, by having the refractive index of the columnar areas 4 provided in the light guiding plate 1 be changeable. Moreover, since the light distribution inside the light guiding plate 1 and the light exiting outside the light guiding plate 1 are carried out in separate layers, it is possible to control the distribution of light and the external emission of light independently from each other.

As a result, for example, with the lighting device 10, it is possible to emit light from the entire upper surface 1b of the light guiding plate 1 or to emit light from just a specific partial area of the upper surface 1b, by carrying out control in the light extraction layer 7. Therefore, the lighting device 10 can serve as a surface light source (backlight unit) that can accommodate to a liquid crystal display device and the like of area-active driving. The B/L accommodating to the sidelight type and area-active type as like the lighting device 10, is superior to a conventional configuration in points such as in the reduction of cost of the device, the reduction in electricity consumption, and the reduction in its thickness. The area-active driving indicates a driving method that divides a display section such as a liquid crystal display device into a plurality of areas to drive the display device, in order to improve contrast in display and the like.

Moreover, the light extraction layer 7 included in the lighting device 10, and the light guiding plate 1, both employ a configuration that can accommodate to a large-sized product. Hence, it is relatively easy to accommodate to the increase in area of the liquid crystal display device or the like that uses the lighting device 10 as its backlight.

(Specific Configuration Example (1) of Light Extraction Layer 7)

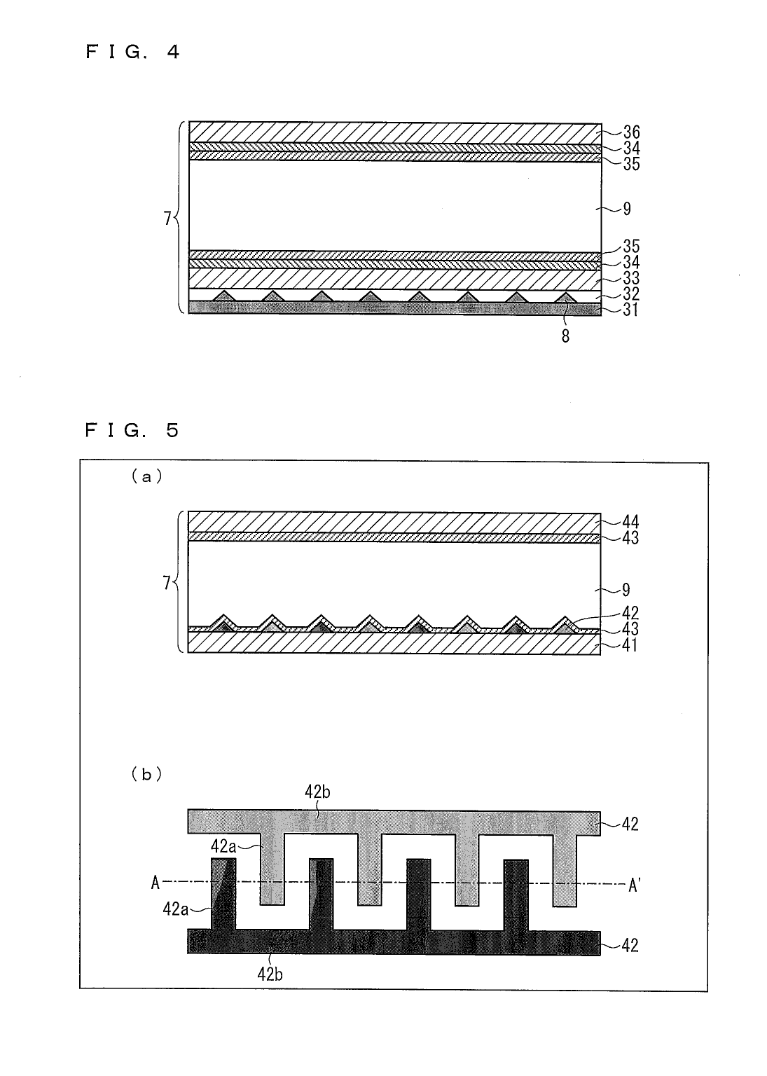

Next described is a specific example of the configuration of the light extraction layer 7, with reference to FIG. 4. However, as in the description with reference to FIG. 2, the light extraction layer 7 is applicable to the present invention and has no particular limitation as long as the light extraction layer 7 includes (i) a light reflecting member that reflects light entered from the light guiding plate 1 and (ii) a shutter member provided between the light guiding plate and the light reflecting member, which shutter member switches between transmission and non-transmission of light or between transmission and scattering of light.

FIG. 4 is a cross sectional view schematically illustrating an example of a configuration of the light extraction layer 7. The light extraction layer 7 is made up of a liquid crystal layer 9 (shutter member) provided between a pair of transparent substrates 33 and 36, and a plurality of light reflecting members 8 provided on one surface of a supporting substrate 31 that has light shielding properties (non-transmission of light). Both the transparent substrates 33 and 36 have a configuration in which an electrode 34 for driving liquid crystal and an alignment film 35 are stacked in this order on their surface that faces the liquid crystal layer 9, and the liquid crystal layer 9 serves as a shutter member by having a voltage be applied between these two electrodes 34.

The supporting substrate 31 is adhered to the transparent substrate 33 with a transparent adhesive resin layer 32 intervening therebetween so that the surface on which the light reflecting members 8 are disposed faces the transparent substrate 33. The transparent substrate 36 is adhered to the light guiding plate 1 on a side facing away of the surface on which the liquid crystal layer 9 and the like are disposed (see FIG. 2).

Light entered into the light extraction layer 7 from the light guiding plate 1 side is controlled as to whether the light is transmitted or not transmitted through the liquid crystal layer 9, by which a part of the light selectively reaches the light reflecting members 8. Upon being reflected on the light reflecting members 8, the light is again controlled as to whether or not the light is transmitted or not transmitted through the liquid crystal layer 9, by which a part of the light is selectively entered into the light guiding plate 1, and further is extracted outside the light guiding plate 1.

(Specific Configuration Example (2) of Light Extraction Layer 7)

Next described is another specific example of the configuration of the light extraction layer 7, with reference to FIG. 5. However, as in the description with reference to FIG. 2, the light extraction layer 7 is applicable to the present invention without any particular limitation as long as the light extraction layer 7 includes (i) a light reflecting member that reflects light entered from the light guiding plate 1 and (ii) a shutter member disposed between the light guiding plate and the light reflecting member, which switches between a light transmitting state and a light non-transmitting state, or between transmission of light and scattering of light.

Schematically illustrated in (a) of FIG. 5 is a cross sectional view of another example of a configuration of the light extraction layer 7. The light extraction layer 7 is made up of (i) a liquid crystal layer 9 (shutter member) being sandwiched between a supporting substrate 41 having light-shielding and insulating properties and a transparent substrate 44, and (ii) a comb-shaped electrode 42 (also serving as the light reflecting member) for driving liquid crystal. The comb-shaped electrode 42 and an alignment film 43 are provided in this order on a surface of the supporting substrate that faces the liquid crystal layer 9. Moreover, the alignment film 43 is provided also on a surface of the transparent substrate 44 that faces the liquid crystal layer 9. The transparent substrate 44 is adhered to the light guiding plate 1 (see FIG. 2) on a surface facing away of the surface on which the liquid crystal layer 9 and the like are provided.

As illustrated in (b) of FIG. 5, two comb-shaped electrodes 42 form a pair, and each of the comb-shaped electrodes 42 are made up of a straight line section 42b extending parallel to each other, and comb sections 42a that extend perpendicularly from the straight line section 42b. The pair of comb-shaped electrodes 42 is disposed so that the comb sections 42a of the two comb-shaped electrodes 42 engage with each other, and applies a voltage to the liquid crystal layer 9.

The (a) in FIG. 5 corresponds to a cross sectional view taken on line A-A′ in (b) of FIG. 5. As illustrated in (a) of FIG. 5, the comb-shaped electrodes 42 are at least formed in such a manner that the comb sections 42a are shaped of a triangular prism shape, and that the comb-shaped electrodes 42 also serve as light reflecting members by being formed with light reflective metal such as aluminum or silver.

Namely, light entered into the light extraction layer 7 from the light guiding plate 1 side is controlled in the liquid crystal layer 9 as to whether or not the light is transmitted through the liquid crystal layer 9, and a part of the light is selectively reached to the comb-shaped electrodes 42, which comb-shaped electrodes 42 also serve as the light reflecting members. After being reflected on the comb-shaped electrode 42, the light is again controlled in the liquid crystal layer 9 as to whether or not the light is transmitted through the liquid crystal layer 9, and a part of the light is selectively entered into the light guiding plate 1 and thereafter further extracted outside of the light guiding plate 1.

### Embodiment 2

(Modified Mode of Light Guiding Unit and Lighting Device)

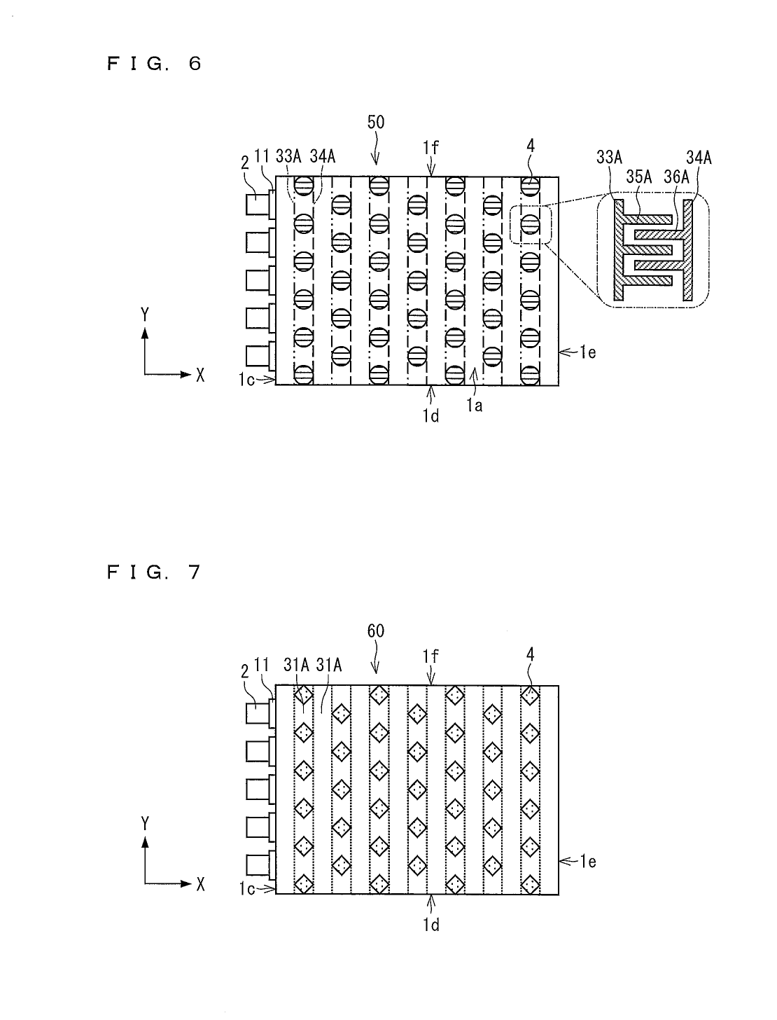

Described below is an example of a basic configuration of a light guiding unit including the light guiding plate of the present invention, and a lighting device, with reference to FIG. 6. Members having identical configurations with those described in Embodiment 1 are provided with identical reference signs, and descriptions thereof have been omitted.

A lighting device 50 according to the present embodiment differs from the lighting device 10 illustrated in FIG. 1 in its electrode configuration that drives the liquid crystal material filled in the columnar areas 4. Namely, in the lighting device 50, a voltage is applied to the liquid crystal material filled in the columnar areas 4 by use of a pair of comb-shaped electrodes 33A and 34A made of transparent electrode material such as ITO or the like (see FIG. 6).

The comb-shaped electrodes 33A and 34A are provided just on the lower surface 1a of the light guiding plate 1, and for example, is formed on a surface of the lower thin film 101 (see FIG. 2) that faces the columnar areas 4. More specifically, the comb-shaped electrodes 33A and 34A extending along an aligned direction of the plurality of LEDs 2 (direction in which the edge surfaces 1c and 1e of the light guiding plate 1 extend) on the lower surface 1a of the light guiding plate 1 serve as one electrode pair, and such electrode pairs are disposed at predetermined intervals. Moreover, the comb-shaped electrodes 33A and 34A include comb-shaped electrode sections 35A and 36A, respectively, which comb-shaped electrode sections 35A and 36A extend perpendicularly from the extending direction of the electrodes 33A and 34A. The comb-shaped electrode section 35A of the comb-shaped electrode 33A is disposed in an interlocking manner with the comb-shaped electrode section 36A of the comb-shaped electrode 34A, however having a spaced provided between the comb-shaped electrode section 35A and the comb-shaped electrode section 36A.

One pair of the comb-shaped electrodes 33A and 34A is provided corresponding to a row of a plurality of columnar areas 4 that are aligned in the extending direction of the comb-shaped electrodes 33A and 34A. Namely, among the edge sections of the columnar areas 4, the edge sections positioned on the lower surface 1a side of the light guiding plate 1 are covered by the comb-shaped electrode sections 35A and 36A of the comb-shaped electrodes 33A and 34A.

The plurality of comb-shaped electrodes 33A are each electrically connected to a first electrode drive circuit (first driver: not illustrated). The first electrode drive circuit supplies a drive signal (voltage signal) to the comb-shaped electrodes 33A, independently. Similarly, each of the plurality of comb-shaped electrodes 34A is electrically connected to a second electrode drive circuit (second driver: not illustrated). The second electrode drive circuit supplies a drive signal (voltage signal) to the comb-shaped electrodes 34A, independently. This enables to have different refractive indices between (i) the columnar areas 4 to which a voltage is applied between the comb-shaped electrodes 33A and 34A (i.e. between the comb-shaped electrode sections 35A and 36A) and (ii) the columnar areas 4 to which no voltage is applied.

Accordingly, by having the refractive index of either of the columnar areas 4 to which the voltage is applied or the columnar areas 4 to which no voltage is applied be substantially equal to the refractive index of the base material of the light guiding plate 1, it is possible to selectively distribute light to its necessary parts, as with Embodiment 1.

The following are some advantageous points in using the comb-shaped electrodes 33A and 34A: (1) electrodes are formed just on one surface of the light guiding plate 1, so therefore production is easier; (2) the electrodes are of a comb shape, so therefore it is possible to secure an area relatively wide on which no electrode is formed in the light guiding plate 1; and (3) since electrodes made of ITO or like material absorbs a part of the light, the light gradually attenuates every time the light enters the electrode, however when the comb-shaped electrodes 33A and 34A are used, electrodes are only formed on one side of the light guiding plate 1, so therefore it is possible to minimize the attenuation of light.

A line width (electrode width) of the comb-shaped electrodes 33A and 34A is designed to be 4 μm, and the pitch of the comb-shaped electrode sections 35A (same applies with the comb-shaped electrode sections 36A) is designed to be 8 μm. However, the line width is not particularly limited to this numerical value. Furthermore, the comb-shaped electrodes 33A and 34A may be provided on just the upper surface 1b of the light guiding plate 1.

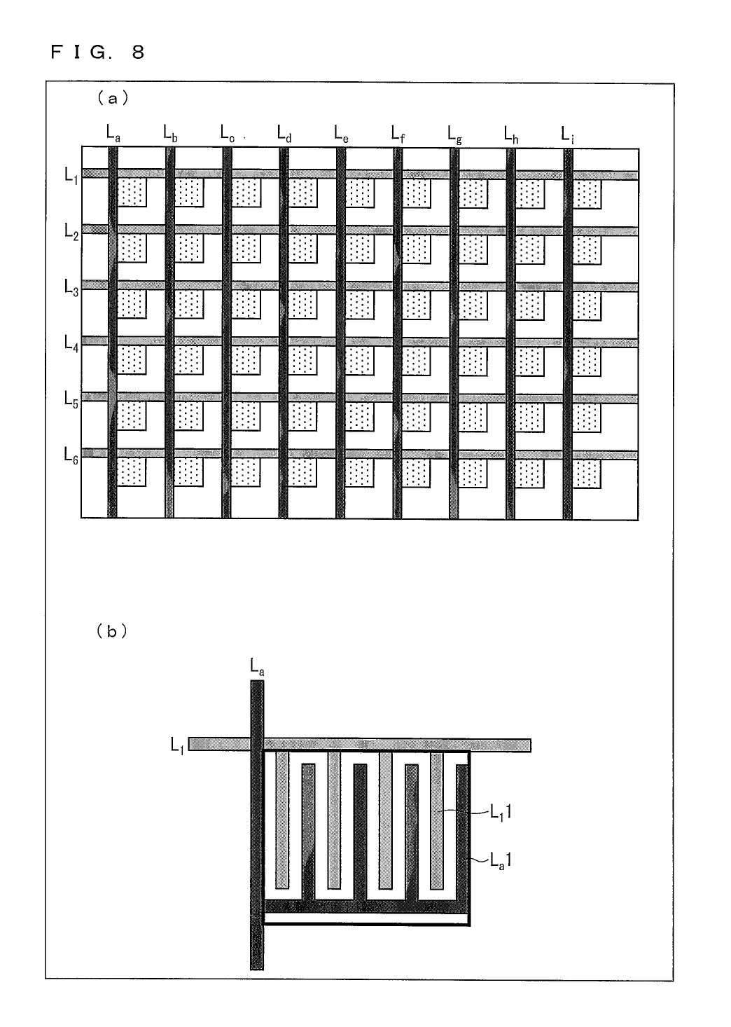

Alternatively, as in the modification illustrated in FIG. 8, the configuration may be one in which the comb-shaped electrodes are arranged in a matrix form, and whether or not a voltage is applied is controllable in units of matrices. Illustrated in (a) of FIG. 8 is a top view of a configuration in which first comb-shaped electrodes L₁ to L₆ and second comb-shaped electrodes Lₐ to Lᵢ are disposed so as to intersect with each other at right angles, and which whether or not a voltage is applied is controllable per intersection of the first and second comb-shaped electrodes.

As illustrated in (b) of FIG. 8, at each of the intersections of the first and second comb-shaped electrodes, a comb-shaped electrode section L₁1 of the first comb-shaped electrodes L₁ to L₆ and a comb-shaped electrode section Lₐ1 of the second comb-shaped electrodes Lₐ to Lᵢ are disposed in such a manner that the comb-shaped electrode section L₁1 and the comb-shaped electrode section Lₐ1 engage with each other. The intersections of the first and second comb-shaped electrodes are provided corresponding to the columnar areas 4 of the light guiding plate 1 (see FIG. 1 and FIG. 2), respectively, from which a voltage is applied to the respective columnar areas 4.

For example, when the first comb-shaped electrodes L₁ to L₆ and the second comb-shaped electrodes Lₐ to Lᵢ are to be disposed on a same surface of the light guiding plate 1, an active matrix element such as a TFT or a TFD is to be formed for each intersection of the comb-shaped electrodes. This allows for independently controlling whether or not a voltage is applied to the columnar areas 4.

Alternatively, even when a passive-matrix driving method is to be employed, in which the first comb-shaped electrodes L₁ to L₆ and the second comb-shaped electrodes Lₐ to Lᵢ are provided on respective surfaces of the light guiding plate 1 that face away from each other, it is possible to independently control whether or not a voltage is applied to the columnar areas 4.

### Embodiment 3

(Modified Mode of Light Guiding Unit and Lighting Device)

Described below is an example of a basic configuration of a light guiding unit including the light guiding plate of the present invention, and a lighting device, with reference to FIG. 7. Members having identical functions to those described in Embodiment 1 are provided with identical reference signs, and descriptions thereof have been omitted.

Embodiments 1 and 2 provided examples whose columnar areas 4 provided in the light guiding plate 1 are of a circular cylinder shape. However, the shape of the columnar areas 4 is not limited to the circular cylinder shape, and further may include columnar areas 4 of a different shape and/or of a different size, within a single light guiding plate 1, if necessary. Moreover, the columnar areas 4 provided in the light guiding plate 1 is not particularly limited to the ones illustrated, not only in their size and shape, but further in their arranged form and arranged pitch, etc.

For example, although not particularly limited, the shape of the columnar areas 4 provided in the light guiding plate 1 may be of shapes such as a triangular prism, a quadrangular prism, an elliptic cylinder, or a circular cylinder, or may use a combination of columnar areas 4 of two or more shapes selected from the foregoing examples. Examples of using the columnar areas of two or more shapes include a combination of a circular cylinder with a polygonal prism shape (e.g. quadrangular prism), or a combination of different polygonal prism shapes (e.g. a triangular prism and a quadrangular prism).

The columnar areas 4 are not particularly limited in its size, however examples thereof are, for example, a size whose equivalent diameter is within a range of not less than 300 μm to not more than 1 mm, within a range of not less than 1 mm to not more than 5 mm, or within a range of not less than 5 mm to not more than 10 mm. More specific examples are, for example, a size (equivalent diameter) of the columnar area 4 being 0.1 mm, 0.3 mm, 0.5 mm, or 1 mm. Moreover, the size of the plurality of columnar areas 4 included in a single light guiding plate 1 may be identical or different from each other. Examples of cases in which the size of the plurality of columnar areas 4 is different are, specifically, cases where the size (equivalent diameter of the columnar areas 4) gradually increases, gradually decreases, or is distributed at random, as the columnar areas 4 become more distant from the edge surface 1c (primary light entering surface) of the light guiding plate 1 on which the LEDs 2 are mounted.

Moreover, the arranged form of the columnar areas 4 is not particularly limited, and may be arranged for example as an aligned state (zigzag arrangement) as illustrated in FIGS. 2, 3, and 6, a honeycomb arrangement, or a random arrangement. A typical example of the honeycomb arrangement is a state in which one columnar area 4 is provided as a center and six columnar areas 4 are disposed surrounding the center columnar area 4 so that the columnar areas 4 take a hexagonal close-packed structure.

Moreover, a pitch between the columnar areas 4 (i.e. arranged pitch) is not particularly limited, and for example may be within a range of not less than 1 mm to not more than 5 mm, within a range of not less than 5 mm to not more than 10 mm, or within a range of not less than 10 mm to not more than 20 mm. The pitch may be of an even pitch, or alternatively, the pitch may gradually increase, gradually decrease, or be distributed at random, as the columnar areas 4 become more distant from the edge surface 1c (primary light entering surface) of the light guiding plate 1 on which the LEDs 2 are mounted. Specific examples of the pitch when the pitch is to be evenly provided are, 1 mm pitch, 5 mm pitch, 10 mm, or the like.

Moreover, the refractive indices of the columnar areas 4 in a state in which no voltage is applied may be higher, lower, or equal to the refractive index of the base material making up the light guiding plate 1.

Furthermore, in order to obtain a desired light distribution within the light guiding plate 1, the refractive index, shape, size, arranged form, and pitch of the columnar areas 4 as exemplified above are used in any combination with each other. Among the combinations, it is advantageous to change the shape of the columnar areas 4, which enables to directly change an angle on which the light from the LEDs 2 enters into the columnar area 4.

One example is a lighting device 60 whose columnar areas 4 are of a quadrangular prism shape, as illustrated in FIG. 7. The arranged form of the columnar areas 4 is similar to those illustrated in FIGS. 2, 3, and 6. When the shape of the columnar areas 4 is of a polygonal prism shape (including the quadrangular prism shape), it is preferable that the columnar areas 4 are arranged so that their side surfaces are angled at a predetermined angle to a light entering direction from the LEDs 2 (i.e. so that the light does not enter the side surface at an angle of 90 degrees). In other words, it is more preferable to arrange the columnar areas 4 so that its side surface is angled (not parallel) with respect to the edge surface 1c of the light guiding plate 1 on which the LEDs 2 are mounted, and is further preferable to have the side surface of the columnar areas 4 be angled with respect to the edge surface 1c in a uniform manner. An arrangement as such allows for further evenly distributing light to surroundings of the columnar areas 4.

(More Specific Mode of Light Guiding Unit and Lighting Device)

A lighting device is prepared, which has a shape, size, arranged form, and pitch of the columnar areas 4 serving as a void section as set described below, with the lighting device 10 illustrated in FIGS. 1 to 3.

### (1) Basic Configuration 1

The columnar areas 4 are shaped of either a circular cylinder or an elliptic cylinder whose size (equivalent diameter) is uniformly 300 μm, and are arranged in the form of a honeycomb shape (hexagonal close-packed structure) with an even pitch of 1 mm. Further, the base material (acrylic material) of the light guiding plate 1 has a refractive index of 1.5, and the columnar areas 4 have refractive indices no (ordinary index) of 1.5 and ne (extraordinary index) of 1.6. Note that one of refractive indices of when a voltage is applied to a columnar area 4 or of when no voltage is applied to a columnar area 4 serves as the ordinary index. Moreover, the electrode configuration illustrated in FIG. 3 is used as the electrode configuration by which the voltage is applied to the columnar areas 4.

### (2) Basic Configuration 2

The columnar areas 4 are shaped of either a circular cylinder or an elliptic cylinder whose size (equivalent diameter) is uniformly 300 μm, and are arranged in the form of a honeycomb shape (hexagonal close-packed structure) with an even pitch of 1 mm. Further, the base material (acrylic material) of the light guiding plate 1 has a refractive index of 1.5, and the columnar areas 4 have refractive indices no (ordinary index) of 1.5 and ne (extraordinary index) of 1.6. Note that one of refractive indices of when a voltage is applied to a columnar area 4 or of when no voltage is applied to a columnar area 4, serves as the ordinary index. Moreover, the comb-shaped electrode configuration illustrated in FIG. 6 is used as the electrode configuration by which the voltage is applied to the columnar areas 4.

### (3) Modified Configuration 1

The columnar areas 4 are shaped of either a triangular prism or of a quadrangular prism (polygonal prism) whose size (equivalent diameter) is uniformly 300 μm, and are arranged in the form of a honeycomb shape (hexagonal close-packed structure) with an even pitch of 1 mm. Further, the base material (acrylic material) of the light guiding plate 1 has a refractive index of 1.5, and the columnar areas 4 have refractive indices no (ordinary index) of 1.5 and ne (extraordinary index) of 1.6. Note that one of refractive indices of when a voltage is applied to a columnar area 4 or of when no voltage is applied to a columnar area 4, serves as the ordinary index. Moreover, the electrode configuration by which the voltage is applied to the columnar areas 4 is identical to one of the basic configurations 1 and 2.

In a case in which the columnar areas 4 of the quadrangular prism shape or the triangular prism shape (polygonal prism shape) are to be used, it is preferable that a side surface of the columnar areas 4, which surface is positioned on the primary light entering side (edge surface 1c side), is arranged so as to be angled with respect to the edge surface 1c of the light guiding plate 1 that serves as the primary light entering surface (i.e. so that the side surface of the columnar areas 4 and the edge surface 1c are not parallel to each other), and is more preferable that the columnar areas 4 are arranged in such a manner that when one columnar area 4 is seen from the edge surface 1c side, that columnar area 4 looks bilaterally symmetrical. This allows for distributing the light even more uniformly, inside the light guiding plate 1.

### (4) Modified Configuration 2

The columnar areas 4 shaped of the circular cylinder and the polygonal prism are employed in combination, whose sizes (equivalent diameter) are uniformly 300 μm, and are arranged in the form of a honeycomb shape (hexagonal close-packed structure) with an even pitch of 1 mm. Further, the base material (acrylic material) of the light guiding plate 1 has a refractive index of 1.5, and the columnar areas 4 have refractive indices no (ordinary index) of 1.5 and ne (extraordinary index) of 1.6. Note that one of refractive indices of when a voltage is applied to a columnar area 4 or of when no voltage is applied to a columnar area 4 serves as the ordinary index. Moreover, the electrode configuration by which the voltage is applied to the columnar areas 4 is identical to one of the basic configurations 1 and 2.

It is preferable that the columnar areas 4 shaped of a polygonal prism are arranged so that their side surfaces positioned on the primary light entering side is angled with respect to the edge surface 1c of the light guiding plate 1 that serves as the primary light entering surface (i.e. so that the side surface of the columnar areas 4 the edge surface 1c are not parallel to each other), and is more preferable that the columnar areas 4 are arranged in such a manner that when one columnar area 4 is seen from the edge surface 1c side, that columnar area 4 looks bilaterally symmetrical. This allows for distributing the light even more uniformly, inside the light guiding plate 1.

### (5) Modified Configuration 3

The columnar areas 4 are shaped of either a circular cylinder or of an elliptic cylinder whose size (equivalent diameter) is uniformly 300 μm, and are arranged in the form of a honeycomb shape (hexagonal close-packed structure) with a pitch gradually increasing (becoming sparse) as the columnar areas 4 become distant from the edge surface 1c of the light guiding plate 1. Further, the base material (acrylic material) of the light guiding plate 1 has a refractive index of 1.5, and the columnar areas 4 have refractive indices no (ordinary index) of 1.5 and ne (extraordinary index) of 1.6. Note that one of refractive indices of when a voltage is applied to a columnar area 4 or of when no voltage is applied to a columnar area 4 serves as the ordinary index. Moreover, the electrode configuration by which the voltage is applied to the columnar areas 4 is identical to one of the basic configurations 1 and 2. Namely, in the modified configuration 3, the columnar areas 4 are arranged so as to be most closely packed in the vicinity of a part in which the LEDs 2 are mounted (primary light entering section).

### (6) Modified Configuration 4

The columnar areas 4 are shaped of either a circular cylinder or an elliptic cylinder whose size (equivalent diameter) gradually decreases as the columnar areas 4 become distant from the edge surface 1c of the light guiding plate 1, and are arranged in the form of a honeycomb shape (hexagonal close-packed structure) with an even pitch of 1 mm. Further, the base material (acrylic material) of the light guiding plate 1 has a refractive index of 1.5, and the columnar areas 4 have refractive indices no (ordinary index) of 1.5 and ne (extraordinary index) of 1.6. Note that one of refractive indices of when a voltage is applied to a columnar area 4 or of when no voltage is applied to a columnar area 4 serves as the ordinary index. Moreover, the electrode configuration by which the voltage is applied to the columnar areas 4 is identical to either of the basic configuration 1 or 2.

Namely, in the modified configuration 4, the columnar areas 4 are arranged so that the amount of light entered into the columnar areas 4 decreases as the columnar areas 4 become distant from the part in which the LEDs 2 are mounted (primary light entering section).

### (7) Modified Configuration 5

The columnar areas 4 are shaped of one of the circular cylinder or of the elliptic cylinder whose size (equivalent diameter) gradually increases as the columnar areas 4 become distant from the edge surface 1c of the light guiding plate 1, and are arranged in the form of a honeycomb shape (hexagonal close-packed structure) with a pitch gradually increasing (becoming sparse) as the columnar areas 4 become distant from the edge surface 1c of the light guiding plate 1. Further, the base material (acrylic material) of the light guiding plate 1 has a refractive index of 1.5, and the columnar areas 4 have refractive indices no (ordinary index) of 1.5 and ne (extraordinary index) of 1.6. Note that one of refractive indices of when a voltage is applied to a columnar area 4 or of when no voltage is applied to a columnar area 4 serves as the ordinary index. Moreover, the electrode configuration by which the voltage is applied to the columnar areas 4 is identical to one of the basic configurations 1 and 2.

Namely, in the modified configuration 5, the columnar areas 4 are arranged so as to have the smallest size and be most closely packed in the vicinity of a part in which the LEDs 2 are mounted (primary light entering section).

### (8) Modified Configuration 6

The columnar areas 4 are shaped of either the circular cylinder or the elliptic cylinder whose size (equivalent diameter) is uniformly 300 μm, and are arranged in the form of a honeycomb shape (hexagonal close-packed structure), with an even pitch of 1 mm. Further, the base material (acrylic material) of the light guiding plate 1 has a refractive index of 1.5, and the columnar areas 4 have refractive indices no (ordinary index) of 1.5 and ne (extraordinary index) of 1.6. Moreover, the electrode configuration by which the voltage is applied to the columnar areas 4 is identical to one of the basic configurations 1 and 2.

The liquid crystal material filled in the columnar areas 4 is material that is isotropic while no voltage is applied, which liquid crystal material exhibits a no (ordinary index) of 1.5. On the other hand, the liquid crystal material exhibits refractive index anisotropy as described above, while a voltage is applied.

(Display Device of Present Invention)

A display device of the present invention includes the lighting device 10 of the present invention as a backlight. The display device is not particularly limited in its type as long as the display device uses a backlight. Specific examples thereof encompass a television receiver, a liquid crystal display device used as a display section of a portable phone, and like device. Among these display devices, the display device is suitably a liquid crystal display device used in a large-sized television receiver.

Moreover, as described above, the lighting device 10 of the present invention is capable of emitting light from the entire upper surface 1b of the light guiding plate 1 through control in the light extraction layer 7, and can emit light from a specific partial area of the upper surface 1b. Hence, it is possible to have the lighting device 10 serve as a surface light source that can accommodate to a liquid crystal display device and the like that is driven by area-active driving. The area-active driving is a driving method that divides a display section of the liquid crystal display device or the like into a plurality of areas and thereafter drives the display section, in order to improve the contrast of display and the like.

As described above, a light guiding unit according to the present invention includes: a light guiding plate made of light-transmitting base material; a plurality of columnar areas provided in a direction intersecting with an in-plane direction of the light guiding plate, each of which is filled with liquid crystal material; and a transparent electrode with which a voltage is applied for driving the liquid crystal material.

In the light guiding unit according to the present invention, it is more preferable that the liquid crystal material has one of its ordinary index or extraordinary index be same as a refractive index of the light-transmitting base material of which the light guiding plate is made.

According to the configuration, it is easy to make a refractive index of light of the columnar areas be substantially same as a refractive index of light of the base material of the light guiding plate, in one of when a voltage is applied or when no voltage is applied to the liquid crystal material with which the columnar areas is filled.

In the light guiding unit according to the present invention, in view that a light guiding condition (incident angle of light) can be maintained within the light guiding plate, it is preferable that the plurality of columnar areas each has a side surface that is substantially perpendicular to the in-plane direction of the light guiding plate and which extends from a front side of the light guiding plate to a rear side of the light guiding plate.

Namely, according to the configuration, light entered into the columnar areas and refracted in a thickness direction of the light guiding plate is again refracted when the light exits that columnar area (again enters into the light guiding plate). This allows for maintaining the incident angle of the light with respect to the light guiding plate, as it is.

In the light guiding unit according to the present invention, it is preferable that the plurality of the columnar areas include columnar areas in shapes of at least two selected from the group consisting of: polygonal prism shapes, a circular cylinder shape, and an elliptic cylinder shape.

Distribution forms of light entered into the columnar areas largely depend on the shape of the columnar areas. Hence, as in the configuration, by including columnar areas of a mixture of different shapes (i.e. with different light distribution forms), it is possible to control the distribution of light in the in-plane direction of the light guiding plate to a desirable form.

The light guiding unit according to the present invention may further include a light extraction layer provided on one surface of the light guiding plate, including a light reflecting member that reflects light entered from the light guiding plate so that the light is exited from a surface of the light guiding plate facing away of the surface on which the light extraction layer is provided.

According to the configuration, light entered into the light guiding plate refracts when entering the plurality of columnar areas provided inside the light guiding plate, and changes its optical path in an in-plane direction of the light guiding plate. This causes light to be distributed so that the light spreads in the in-plane direction of the light guiding plate. On the other hand, the light entered from one side of the light guiding plate into the light extraction layer is reflected on the light reflecting member provided inside the light extraction layer, and exits outside the light guiding plate.

Namely, in the light guiding unit, the distribution of light in the in-plane direction of the light guiding plate and the exiting (extraction) of light outside the plane of the light guiding plate are carried out in different layers. This allows for independently controlling the distribution of light and the exiting of light outside.

In the light guiding unit according to the present invention, it is preferable that the light extraction layer includes (i) a liquid crystal layer and (ii) the light reflecting member, the light reflecting member being disposed so as to face the light guiding plate, the light extraction layer having the liquid crystal layer be sandwiched between the light reflecting member and the light guiding plate.

According to the configuration, light entered from the light guiding plate into the light extraction layer reaches the light reflecting member through a liquid crystal layer that is driven by having the liquid crystal layer be applied a voltage. The liquid crystal layer serves as a shutter, and causes light to reach the light reflecting member on just a desired area, thereby making it possible to have the light exit outside the light guiding unit just from the desired area. Hence, it is possible to provide a new light guiding unit that can also accommodate to a display device that carries out area-active driving.

The present invention is not limited to the description of the embodiments above, but may be altered by a skilled person within the scope of the claims. An embodiment based on a proper combination of technical means disclosed in different embodiments is encompassed in the technical scope of the present invention.

### INDUSTRIAL APPLICABILITY

According to the present invention, it is possible to provide a new light guiding unit and the like that can also accommodate to area-active driving.

### REFERENCE SIGNS LIST

1 light guiding plate
1c edge surface
2 LED (primary light source)
4 columnar area (columnar area)
7 light extraction layer
8 light reflecting member
9 liquid crystal layer
10 lighting device
11 light source mounting section (mounting section)
31A, 32A electrode (transparent electrode)
33A, 34A comb-shaped electrode (transparent electrode)

1. A light guiding unit, comprising:
a light guiding plate made of light-transmitting base material;
a plurality of columnar areas provided inside the light guiding plate in a direction intersecting with an in-plane direction of the light guiding plate, each of which is filled with liquid crystal material; and
a transparent electrode with which a voltage is applied for driving the liquid crystal material.

2. The light guiding unit according to claim 1, wherein
the liquid crystal material has one of its ordinary index or extraordinary index be same as a refractive index of the light-transmitting base material of which the light guiding plate is made.

3. The light guiding unit according to claim 1, wherein
the plurality of columnar areas each has a side surface that is substantially perpendicular to the in-plane direction of the light guiding plate and which extends from a front side of the light guiding plate to a rear side of the light guiding plate.

4. The light guiding unit according to claim 1, wherein
the plurality of columnar areas include columnar areas in shapes of at least two selected from the group consisting of: polygonal prism shapes, a circular cylinder shape, and an elliptic cylinder shape.

5. The light guiding unit according to claim 1, further comprising:
a light extraction layer provided on one surface of the light guiding plate, including a light reflecting member that reflects light entered from the light guiding plate so that the light is exited from a surface of the light guiding plate facing away of the surface on which the light extraction layer is provided.

6. The light guiding unit according to claim 5, wherein
the light extraction layer includes (i) a liquid crystal layer that is driven by being applied a voltage and (ii) the light reflecting member, the light reflecting member being disposed so as to face the light guiding plate, the light extraction layer having the liquid crystal layer be sandwiched between the light reflecting member and the light guiding plate.

7. The light guiding unit according to claim 1, wherein
the liquid crystal material filled in the columnar areas is uniaxial liquid crystal material.

8. The light guiding unit according to claim 1, wherein
the liquid crystal material filled in the columnar areas is liquid crystal material exhibiting isotropy when no voltage is applied.

9. The light guiding unit according to claim 1, wherein
the transparent electrode with which a voltage is applied for driving the liquid crystal material is (a) an electrode pair disposed on either edge sections of the columnar areas, or (b) an electrode pair shaped of a comb, disposed on one of the edge sections of the columnar areas.

10. A lighting device, comprising:
a light guiding unit as set forth in claim 1; and
at least one primary light source disposed on an edge surface of the light guiding plate.

11. A display device comprising, as a backlight, a lighting device as set forth in claim 10.
